(19) United States
(12) Patent Application Publication
(10) Pub. No.: US 2014/0196638 A1
(43) Pub. Date: Jul. 17, 2014

(54) COMBUSTION DEVICE AND A METHOD FOR COMBUSTING GRANULAR, SOLID FUEL

(71) Applicants: Matti Pappinen, Polvijarvi (FI); Mikko Pappinen, Vaivio (FI)

(72) Inventors: Matti Pappinen, Polvijarvi (FI); Mikko Pappinen, Vaivio (FI)

(73) Assignee: Konepaja M. Pappinen Oy, Polvijarvi (FI)

(21) Appl. No.: 14/343,151

(22) PCT Filed: Sep. 6, 2012
(86) PCT No.: PCT/FI2012/050864

§ 371 Date: Mar. 6, 2014

(30) Foreign Application Priority Data
Sep. 6, 2011 (GB) 1115341.8

(51) Int. Cl. F24B 1/02; F23Q 3/00; F23L 9/00; F27B 7/30; F24B 13/04; F23L 5/02

(52) U.S. Cl. CPC F24B 1/026; F24B 1/024; F24B 13/04; F23L 5/02; F23L 9/00; F27B 7/30; F23Q 3/00
USPC 110/341; 110/267; 110/297; 110/110; 110/317; 110/214; 431/258

(57) ABSTRACT

Disclosed is a combustion device and method for combusting granular, solid fuel, for example wood pellets. The combustion device includes a chamber having an outer wall and an inner wall, which inner wall divides the chamber into a combustion air space and a combustion chamber. Further, the combustion device includes at least one blast apparatus for providing primary combustion air and secondary combustion air and a rotating unit for rotating the combustion chamber. The inner surface of the combustion chamber includes a number of steps for lifting combustion fuel in the combustion chamber, when the combustion chamber is rotated. Further, primary combustion air is provided into the combustion chamber for contributing combustion of combustion fuel and for moving combustion fuel on the steps. In addition, secondary combustion air is provided into the combustion chamber for removing completely combusted fuel and/or combustion gases from the combustion chamber.

### TECHNICAL FIELD

Generally, the invention relates to a combustion device. More specifically, the invention relates to a combustion device and a method for combusting granular, solid fuel, for example wood pellets.

### BACKGROUND TECHNOLOGY

Nowadays, granular solid fuel combustion devices, hereinafter referred as combustion devices, such as pellet stoves, are replacing conventional oil heating systems, especially in two or one-family houses. This phenomenon is caused by several reasons; oil price is increasing every year causing more expenses to dwellers, numerous people experience environmental concerns about using fossil fuels and usage of renewable energy is subsidized with state funds in many states, just to name a few.

Usage of combustion device for solid, granular fuel can also be an environmental and economical choice; solid fuel is typically non-toxic and easy to handle and, being also renewable fuel, it is less expensive comparing to oil, for example. In addition, wood pellets, as an example of solid, granular fuel, are extremely dense and can be produced with low humidity content, which may allow them to be burned with very high combustion efficiency.

Though, there are many similarities between combustion devices and conventional oil heating system, the combustion devices suffer from some disadvantages: it happens often that combustion devices consume more fuel than they should be, because the combustion process does not completely burn fuel. Due to this, partly burned fuel can fill the combustion chamber and may also induce damage to the combustion chamber, if the unburned or partly burned fuel particle melts to the wall of the combustion chamber. Because of that, the combustion device has to be frequently emptied and cleaned, which can be laborious and difficult process to perform. Additionally, ash of the combusted fuel has to be removed from the combustion chamber in some manner. If not carefully removed, ash residues eventually fill the chamber and may clog air ways, which may decrease the combustion efficiency and increase fuel consumption. In addition, ash and incompletely combusted fuel may cause impure combustion process, which increases number of undesired fine particles in air.

Prior art knows several grate solutions preventing the melting of the fuel. One example is disclosed in document RU2371634C, wherein the grate has a staggered profile, which is also provided into a reciprocating motion. Unfortunately, this solution does not solve the problem of partly burned fuel and, therefore, does not reduce the fuel consuming.

The other prior art solution is disclosed in document EP0126619 B1, wherein the combustion device comprises means for lifting and cascading combustible solids in order to achieve high combustion efficiency. However, that solution does not solve the problem of ash, which congregates into the combustion chamber and may hinder the air supply to the combustion process.

Unfortunately, solutions described above do not solve the problem of the accumulating ash, either.

### SUMMARY OF THE INVENTION

The purpose of the present invention is to avoid or, at least, reduce disadvantages of the prior art solutions described above.

The object of the invention is achieved with a solution, wherein a combustion device for granular, solid fuel is arranged to elevate fuel particles in a combustion chamber and to provide combustion air flows in appropriate angels so as to completely combust the fuel particles into ash and to remove completely combusted fuel, which is sufficiently lightweight, and/or combusting gases from the combustion chamber.

A combustion device for combusting granular solid fuel according to the present invention is characterized by the features of claim 1.

According to a preferable embodiment the combustion device for combusting granular, solid fuel in accordance with the present invention comprises a chamber having an outer wall and an inner wall, which inner wall divides the chamber into a combustion air space and a combustion chamber. Further, the combustion device comprises at least one blast apparatus for providing primary combustion air and secondary combustion air and rotating means for rotating the combustion chamber.

The inner surface of the combustion chamber comprises a number of steps for lifting combustion fuel in the combustion chamber, when the combustion chamber is rotated. Further, primary combustion air is provided into the combustion chamber for contributing combustion of combustion fuel and for moving combustion fuel on the steps. In addition, secondary combustion air is provided into the combustion chamber for removing completely combusted fuel and/or combustion gases from the combustion chamber.

In one embodiment the combustion chamber has a shape of a cylinder. Cylindrical form of the combustion chamber is preferable, because the rotation of the chamber is essential in the present invention.

In one embodiment, the combustion device comprises one blast apparatus, which blast apparatus is arranged to provide both primary combustion air and secondary combustion air into the combustion chamber as well as cooling of the chamber of the combustion device. In another embodiment, the combustion device also comprises an afterburning part with an afterburning combustion air. The afterburning part preferably comprises e.g. a collar for diminishing the radius of an output opening provided in the afterburning part as a passage for completely combusted fuel and/or combustion gases to exit from the combustion chamber. The collar of the afterburning part is advantageous, because it physically prevents incompletely combusted fuel to exit from the combustion chamber.

Yet, in another embodiment the combustion air space is continuous. Continuous air space is advantageous, because continuous air space may enable the usage of one blast apparatus for providing all needed combustion air types; primary combustion air, secondary combustion air and supplementary afterburning combustion air.

Yet, in one embodiment, the steps inside the combustion chamber are coupled together and in another embodiment, at least one aperture is provided through at least one step for directing primary combustion air into the combustion chamber.

In one embodiment, the inner surface of the combustion chamber, especially the steps inside the combustion chamber, is coated with some appropriate high temperature resistant coating material, such as ceramic coating, for improving the combustion process. The usage of the coating is advantageous, because it may further prevent combustion fuel particles to stick into the surface of the combustion chamber.

In one embodiment, the combustion chamber comprises at least one aperture for providing secondary combustion air into the combustion chamber in a direction substantially parallel to the rotation axis of the combustion chamber.

In one embodiment, the rotating movement of the combustion chamber is pulsating, and in another embodiment, the pulsating rotating movement of said combustion chamber is adjustable according to the fuel type and/or size.

Yet, in one embodiment, the combustion device further comprises a feeding device, such as a helix, for feeding combustion fuel to said combustion chamber, and in another embodiment, the combustion device further comprises a lighting means, such as electric and/or wire-wound resistor, for heating the combustion air as to igniting combustion fuel to be fed into the combustion chamber.

A method for combusting granular, solid fuel using combustion device according to the present invention is characterized by the features of claim 17.

In one embodiment, a method for combusting granular, solid fuel using combustion device of the present invention comprises following phases:
feeding granular, solid, ignited fuel to the beginning of said combustion chamber;
providing said combustion chamber into a rotating movement for lifting fuel by means of said steps forming the inner surface of said combustion chamber;
providing primary combustion air into said combustion chamber in a direction substantially parallel to and/or along the circumference of said combustion chamber for combusting and moving said combustion fuel in said combustion chamber;
providing secondary combustion air into said combustion chamber in a direction substantially parallel to a rotation axis of said combustion chamber for removing completely combusted fuel and/or combustion gases from said combustion chamber.

Some preferable embodiments of the invention are described in the dependent claims.

Significant advantages can be achieved with the present invention when compared to the prior known solutions. For one thing, the combustion device according to the present invention may be suitable for various granular, solid fuels, such as wood pellets, biomass pellets, peaty pellets, turf pellets, homogenous wood chips and coal. In addition, a conventional oil heating system used in two or one-family houses may be replaced with the combustion device according to the present invention.

The combustion method of the present invention may provide both efficient and complete combustion air mixing in a vortex and at high temperature inside the combustion chamber, which may ensure that gas phases of fuel may not be able to escape or may not remain incompletely combusted due to lack of combustion air. As an effect of the combustion method, the temperature of combustion gases may reach up to 850° C.-1100° C. inside the combustion chamber. The vortex inside the combustion chamber combined with the coated surface of the combustion chamber may further improve the combustion process by alleviating and enhancing a collision of the combustion fuel particles on the steps.

Furthermore, the combustion process may be possible to improve more by using an additional afterburning part of the present invention, which afterburning part may physically prevent incompletely combusted fuel particles to exit from the combustion chamber before the fuel particles are sufficiently lightweight due to the burning process. In addition, the afterburning part may further improve the combustion process by providing an afterburning combustion air flow in an appropriate direction, which may increase the temperature of combustion gases e.g. 100° C.-150° C. and may cause more completely burning of fuel particles.

Furthermore, due to the efficient burning, it may be possible to reduce undesired fine particles in air caused by the incomplete combustion process. This efficient burning process may also decrease the consumption of fuel, which may bring savings both in expenses and in environmental resources.

Due to the complete combustion of the solid fuel and arranged ash removing system from combustion chamber, the emptying and cleaning of the combustion chamber may be possible to accomplish less frequently, which may reduce necessity to halt the heating system for emptying and cleaning, and may enable long, continuous running of the combustion device. The cleaning time range may be even eight months or longer, for example, which may usually be sufficiently long time to utilize the combustion device according to the present invention throughout the whole heating season.

The rotating movement and efficient air supply may together prevent the melting and attaching of solid fuel particles to the combusting chamber, even with large fuel particles. In addition, the coated surface with its non-stick surface may further improve movements and collisions of combustion fuel particles on steps by reducing friction between combustion particles and steps, which further prevent the melting and/or sticking of fuel particles into the surface of the combustion chamber. Furthermore, the coated surface with its non-stick surface may alleviate the emptying and cleaning procedure by providing easy to clean surface.

The combustion process using the present invention can be made continuous with an automated feeding system, which may reduce required controlling of the combustion system by a user. The feeding system may be arranged so that a small flame is maintained in the combustion chamber all the time, which may reduce undesired fine particles in air caused by starting process of the combustion device.

In addition, the pulsating rotation movement may ensure that older, burning fuel particles are lifted by the steps to a higher level, until they fall on newer fuel, which may mince combustion fuel particles and improve the efficient fuel combustion.

Moreover, the combustion device according to the present invention may not need separate cooling means, because combustion air provided by the blast apparatus may also be arranged to act also as an air cooler for the whole chamber of the combustion device and especially for the combustion chamber. Also smaller parts, such as bearings inside the chamber may also be cooled by the combustion air.

Finally, the combustion device may be simpler and less expensive to manufacture, because only one air supply is needed to produce both primary and secondary combustion air as well as afterburning combustion air. Moreover, cooling of the combustion chamber is implemented with the same air supply.

The term “granular, solid fuel” refers herein to a combustible material for producing energy, such as, but not limited to, wood pellets, biomass pellets, peaty pellets, turf pellets, homogenous wood chips and coal.

In addition, the term “combustion fuel particle” refers herein to a particular combustion piece, which size can vary depending on the combustion fuel type and the combustion process.

The direction terms, such as “in front of” and “beginning of” used in this document, refer to the proceeding direction of combustion fuel.

### SHORT DESCRIPTION OF THE DRAWINGS

Next, the invention is described in more detail with reference to the appended drawings, in which

FIG. 1 depicts a cross section view of a combustion device according to an embodiment of the present invention;

FIG. 2 depicts a front view of a chamber of the combustion device according to an embodiment of the present invention;

FIG. 3 depicts a side view of a step of a combustion chamber according to an embodiment of the present invention;

FIG. 4 depicts a front view of a step according to FIG. 3;

FIG. 5 depicts a partial view of a combustion chamber according to FIG. 2;

FIG. 6 is a flow chart of the combustion process by using combustion device according to the present invention.

### DETAILED DESCRIPTION OF THE EMBODIMENTS

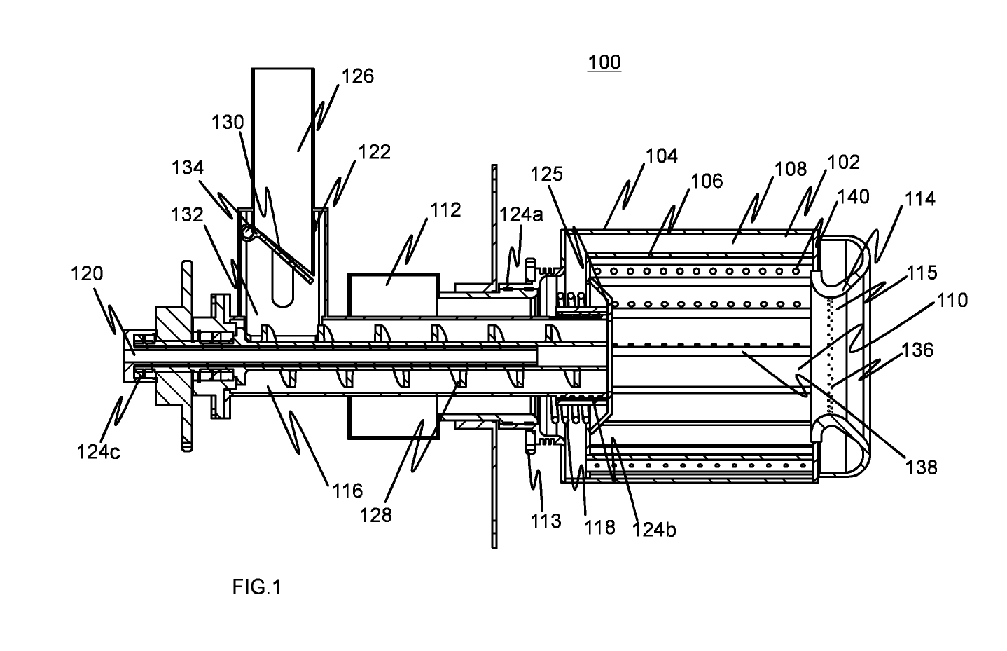

Next, components and function of a combustion device according to the present invention is discussed with reference to FIGS. 1-5. A combustion device 100 for combusting granular, solid fuel comprises a chamber 102 having an outer wall 104 and an inner wall 106, which inner wall 106 divides an inner space of the chamber 102 into a combustion air space 108 and a combustion chamber 110; at least one blast apparatus 112 for providing primary combustion air and secondary combustion air and rotating means 113 for rotating the combustion chamber 110.

In one embodiment, the combustion device according to the present invention further comprises an afterburning part 114 connected to the chamber 102 for ensuring complete combustion of combustion fuel and/or combustion gases and for preventing incompletely combusted material to exit from the combustion chamber 110, a feeding device 116 for feeding combustion fuel to said combustion chamber, and lighting means 118 for igniting combustion fuel by heating combustion air.

In addition, the combustion device according to the present invention may further comprise a flame control system 120 and/or extinguishing equipment 122, as well as appropriate bearings 124a, 124b, 124c disposed in appropriate places, for example.

The operation of the feeding device is now discussed. A person skilled in art will understand that the feeding device depicted in FIG. 1 is only supplementary arrangement for feeding fuel to the combustion device according to the present invention and the combustion device may comprise another feeding device operating in some other way or the fuel feeding is arranged in some other way.

The exemplary feeding device 116 in FIG. 1 comprises e.g. a feeding tube 126, a protective valve 130, conveying means 128, a flame control system 120 and extinguishing equipment 122.

The feeding tube 126 of the feeding device 116 is usually in connection with a fuel store (not shown) from its upper end and is in conjunction with conveying means 128 from its lower end. The feeding tube 126 in FIG. 1 is assembled in substantially vertical position and comprises a protective valve 130 for preventing fire to access to the fuel store. The protective valve 130 is preferably connected to the feeding tube 126 so that a suitable interspace 132 remains between the protective valve 130 and conveying means 128 allowing appropriate amount of fuel to be conveyed to the combustion chamber 110, and preventing fuel to hamper the operation of the protective valve 130, i.e. ensuring the unobstructed opening and closing of the valve 130.

Preferably, the protective valve 130 has a form of a flap and can be made of e.g. steel, aluminium or some other appropriate, durable and fireproof material. The protective valve 130 is installed in an askew position inside the tube 126 by connecting the protective valve 130 to the feeding tube 126 with a joint hinge 134 from its upper side, which brings the protective valve 130 to act as a gravity-operated flap allowing an appropriate amount of fuel to access to the interspace 132. The askew position of the protective valve 130 ensures that combusting fuel pile to the lower side of the valve 130, which may enhance appropriate amount of fuel to push aside the protective valve 130 when dropping onto the valve 130. The protective valve 130 may further comprise adjusting means for adjusting the stiffness of the joint hinge 134, i.e. adjusting the weight of fuel needed to open the gravitational-operated protective valve 130.

The conveying means 128 comprises means, e.g. a helix, for conveying appropriate amount on combusting fuel to the combustion chamber 110 at a time. Preferably, the combustion chamber 110 locates at the end of the conveying means 128 in a substantially horizontal axis. Typically, the lighting means 118, such as, but not limited, an electric and/or wire-wound resistor, is preferably disposed just before the combustion chamber 110 for igniting combustion fuel.

Furthermore, in FIG. 1, the additional flame control system 120 is disposed to the other end of the conveying means 128 inside the helix. The location inside the helix is advantageous, because in that spot the flame control system 120 has an unobstructed view to the combustion chamber 110, the temperature is low compared to the combustion chamber 110 and the flame control system 120 is protected from external distraction, such as combustion fuel and another components of the device 100. The bearings 124c can be used for fixedly attaching the flame control system 120 to the conveying means 128. Moreover, extinguishing equipment 122 can be connected to the feeding device, preferably in a near connection with the protective valve 130. The extinguishing equipment 122 can comprise means for e.g. releasing firefighting water into the feeding device 116 in case of fire.

Inside the helix can also be disposed various measuring means, such as a temperature sensor/sensors for detecting temperature in the conveying means 128 and/or in combustion chamber 110. In addition or instead of temperature sensor, the flame control system 120 may comprise some other means, such as optical and/or infrared sensor(s), for observing undesired fire in conveying means when igniting fuel. The measuring means for detecting the temperature inside the combustion chamber normally detects the temperature substantially at the beginning of the combustion chamber. Measurements concerning to the combustion chamber, such as temperature detection, are preferably performed from inside the helix, which provides good protection for measurement devices and unobstructed visibility to the combustion chamber as well as realtime measurements.

The combustion device according to the present invention can be reliably controlled based on the measurements performed from inside the helix. For example, feeding of the fuel can be adjusted according to the temperature of the combustion chamber, because e.g. too much fuel decreases the temperature, which can be easily detected by the temperature sensor, and the feeding device may become jammed because of excessive fuel. In addition, the combustion chamber can be reliably and safely run down by detecting the temperature of the combustion chamber. When running down procedure is performed, at first the fuel feeding is stopped, but the conveying means is kept on running so that all fuel exits from the conveying means. Also the blast apparatus is kept on blowing air to the combustion chamber for feeding all kinds of combustion air into the combustion chamber and for cooling the combustion chamber. The temperature of the combustion chamber is detected in realtime during the whole process and when the temperature decreases to sufficiently low, for example to 50° C., the functions of the combustion chamber can be shut down.

In FIG. 1, the blast apparatus 112 is disposed around the conveying means 128 before the lighting means 118 and the air of the blast apparatus is heated with lighting means for igniting fuel. The location of the blast apparatus 112 is preferably selected so that the air flow produced by the blast apparatus 112 can be used as a primary combustion air, a secondary combustion air, for cooling the chamber and components therein, for ignition and, in embodiments comprising the afterburning part 114, as an afterburning combustion air. The air flow of the blast apparatus 112 may vary depending on the size of the combustion chamber and/or the output capacity of the combustion device. For producing e.g. 100 kWh, the air flow of the blast apparatus can preferably be e.g. about 20 l/s-35 l/s, more preferably e.g. about 25 l/s-30 17 s and most preferably e.g. about 26 l/s-27 l/s. The structure of the combustion device and its air space as well as losses may affect the amount of air.

Typically, the device comprises one or more oxygen and/or lambda sensors, which are arranged to observe the amount of carbon monoxide in the combustion gases. The amount of carbon monoxide in the combustion gases normally gives reliable information about needed air and the air flow can adjusted according to this information. Advantageously, the air flow is adjusted so that a high pressure is provided into the air space.

The chamber 102 of the combustion device is divided into the combustion air space 108 and the combustion chamber 110 by the inner wall 106. The combustion chamber 110 is roughly in the form of a cylinder, as well as the chamber 102 of the combustion device 100. It will be apparent to those skilled in art that the form of the outer form chamber 102 of the combustion device 100 can vary as long as the cylindrical combustion chamber 110 fits into the chamber and the air space in the chamber 102 remains continuous.

The chamber 102 comprises an opening at the beginning of the chamber 102 for feeding combustion fuel into the combustion chamber 110, which opening can be connected with the feeding device 116, and another opening at the end of the chamber 102 for removing completely combusted fuel and ash from the combustion chamber 110.

The chamber 102 of the combustion device 100 is preferably manufactured from some durable material and, particularly, the combustion chamber 100 is manufactured from material, which is especially resistant for fire and high temperature, such as steel.

The size of the chamber 102 may vary depending on required output capacity of the combustion device, which can be e.g. between 10 kW-20 MW. For combustion devices intended to one- or two-family houses, the output capacity can be e.g. about 15 kW-60 kW, preferably e.g. about 25 kW-40 kW. Typically, the corresponding length of the chamber in axial direction can preferably be e.g. about 200 mm-290 mm, more preferably e.g. about 220 mm-270 mm and most preferably e.g. about 250 mm-260 mm. Respectively, the diameter of the chamber direction can preferably be e.g. about 160 mm-300 mm, more preferably e.g. about 168 mm-270 mm, and most preferably e.g. about 170 mm-240 mm.

Otherwise, the size of the chamber 102 can be described by the volume of the combustion chamber 110. The volume of the combustion chamber 100 can preferably be e.g. about 5.0 dm³-14 dm³, more preferably e.g. about 5.5 dm³-12 dm³, and most preferably e.g. about 6.5 dm³-10 dm³. The volume can also be selected to correspond to the output capacity of the combustion device. To every kW the volume increases a square root. Furthermore, the volume of the chamber depends on the used combustion fuel type. Wood chips, for example, contain less energy than turf pellets, about quarter less, but contain 20%-30% water, i.e. have more moisture than e.g. turf pellets, need a combustion chamber with larger volume to produce the same output capacity. The volume of the combustion chamber for wood pellets can be e.g. 50% larger than for peat/turf pellets, for example.

The inner wall 106 of the chamber 102 is preferably formed by a number of steps 138, which thus form the inner surface of the combustion chamber 110. Depending on an embodiment, an aperture/a number of apertures 140 are provided through at least one step. In a preferred embodiment, a number of apertures are provided through each step. The structure and function of steps will be discussed in more detail below.

In one embodiment, the chamber 102 of the combustion device 100 is arranged to rotate by the rotating means 113, such as a servo motor or some other suitable motor system. In another embodiment, only the combustion chamber 110 is arranged to rotate. Anyway, the rotation of the combustion chamber 110 is essential in the present invention. Depending on embodiment, the rotating procedure can be continuous, pulsating or some other suitable movement; in any case, the rotating parameters, such as rotation speed and/or pulsating time, i.e. driving/rest ratio, are preferably adjustable. In a preferably embodiment, the rotation procedure is pulsating. Considering different types of fuel used in the combustion device, controlling the rotation procedure is advantageous, since different fuel types may need different combustion time.

The used pulsating time ratio can preferably be e.g. about 1 s-4 s driving and about 100 s-700 s rest, more preferably e.g. about 1.5 s-3 s driving and about 150 s-600 s rest, and most preferably e.g. about 2 s-2.5 s driving and about 200 s-400 s rest, wherein the driving speed can be about 1 degree/second, for example. The driving direction is preferably to a shorter part of a step. It should be understood that the driving/rest ratio also depends on used fuel type and the following values are given as exemplary values for exemplary fuel types. Thus, when using wood based fuel having a high ash melting point, the driving/rest ratio of rotation means can be e.g. about 2 s/600 s. On the other hand, when the used e.g. biomass pellets or peaty/turf pellets having a lower ash melting point, the driving/rest ratio should be shorter, e.g. about 2 s driving and about 150 s-200 s rest. Therefore, the used driving/rest ratio is mainly determined by the ash melting point of the used fuel.

The rotating means 113 are preferably functionally connected to controlling means (not shown) having a user interface and/or software for controlling the rotation. In one embodiment, the user can adjust the rotating parameters and, in another embodiment, the software adjusts the rotating parameters according to the information of used fuel provided by the user and/or additional detector(s) connected to the combustion device. In that case, the software can be provided to use suitable table and/or to calculate appropriate parameters for the rotation. It will be apparent to those skilled in the art that other procedures, such as feeding rate, air flow of the blast apparatus, lighting as well as flame control and/or extinguishing equipment may also be arranged to be controlled and/or monitored by the same controlling means and/or via user interface.

Further, the chamber 102 of the combustion device preferably comprises appropriate bearings 124a and 124b, such as, but not limited to, brass carbon based bearings, bronze bearing and/or bearing tape comprising bronze, for keeping the chamber fixedly positioned in axial direction of chamber 102. The combustion air produced by the blast apparatus 112 provides cooling especially for the bearings 124b, and a centre plate 125 attached to the beginning of the combustion chamber 110 provides physical shield for the bearings 124b. Normally, required lubrication is also arranged for the bearings.

The combustion air space 108 is provided in front of and around the combustion chamber 110 so that the combustion air space 108 spans in front of the combustion chamber 110 and spans at the end of the combustion chamber 110, as can be seen in FIG. 1. In embodiments comprising the afterburning part 114, the combustion air space continues to the afterburning part 114. The air space is preferably continuous so that combustion air provided by the blast apparatus 112 can be used as primary combustion air and secondary combustion air as well as afterburner. In addition, the blast apparatus 112 provides cooling for chamber of the combustion device as well as components therein. Primary combustion air and secondary combustion air are discussed in more detail below.

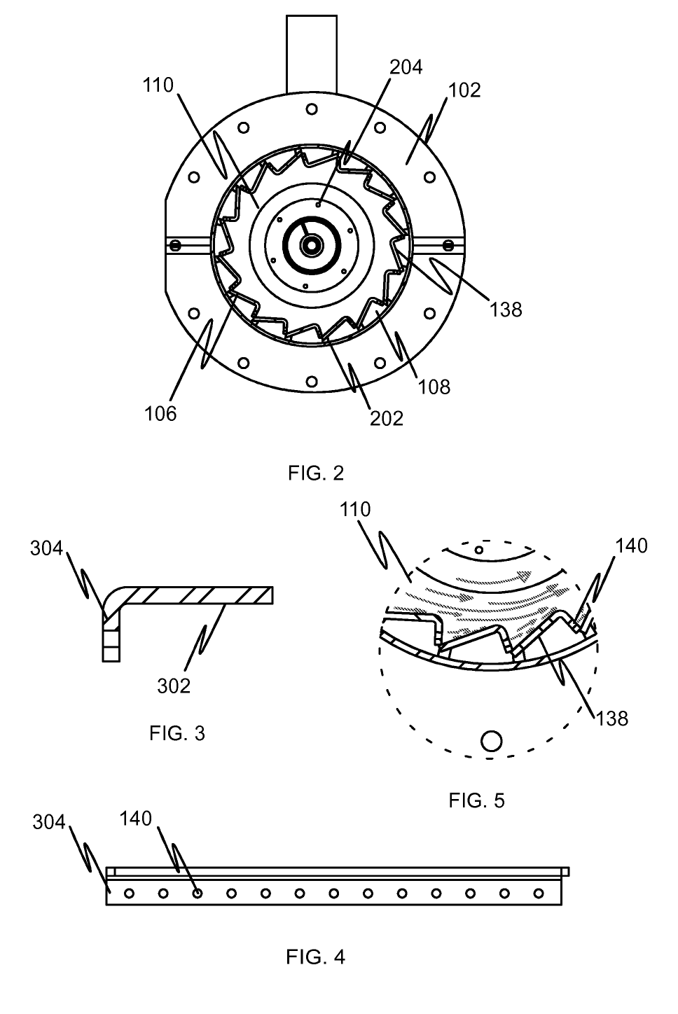

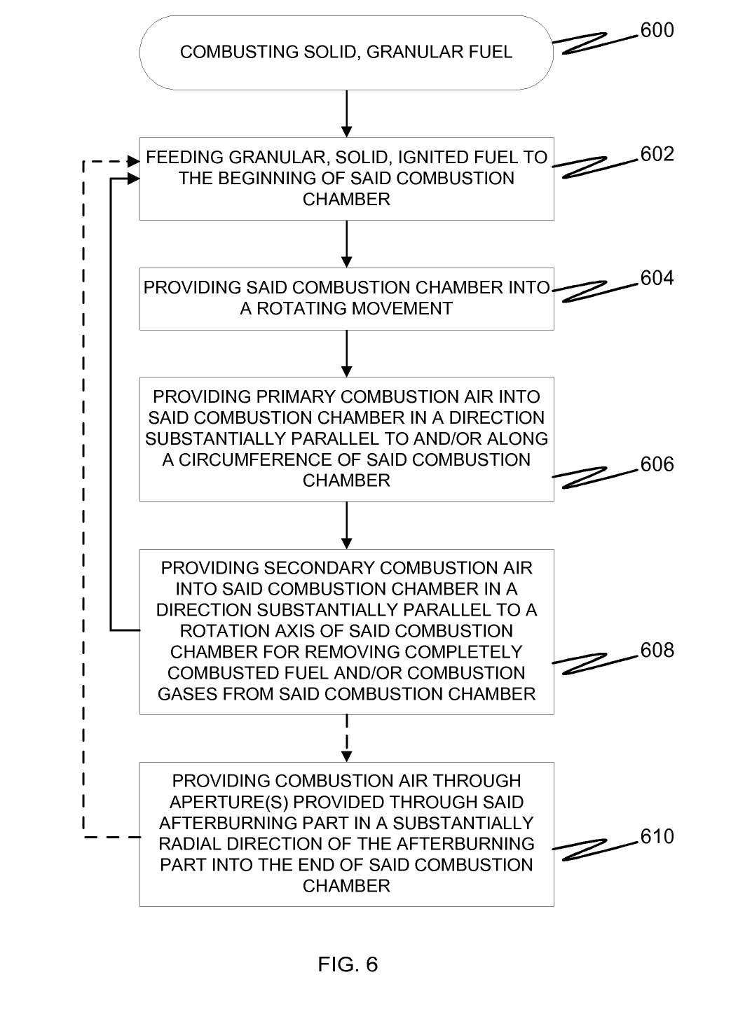

FIG. 2 depicts a front view of the chamber 102 of the combustion device according to an embodiment of the present invention. As described above, the inner surface of the combustion chamber 110 is formed by steps 138, which steps 138 are, in a preferred embodiment, evenly disposed in the combustion chamber 110. The steps can be disposed substantially in a horizontal position in the combustion chamber, or in another embodiment, the steps are disposed in an askew position so that the combustion fuel moves inside the combustion chamber to the end of the chamber. The askew position of steps can be achieved by assembling the chamber in an askew position. The degree of the askew position can be e.g. about 1-5 degrees.

The steps 138 can be installed in a supporting frame 202 or, in one embodiment, the steps 138 are coupled together so that the succeeding step begins where the preceding step ends. In that case, any supporting frame may not be required, but the steps 138 form the whole inner wall 106. When using the supporting frame 202 as a part of the inner wall 106, the steps 138 can also be installed in it by leaving a distance between steps.

The number of steps 138 at the inner surface of the combustion chamber 110 may vary depending on the size of the combustion chamber 110 and the size of the steps 138, but typically there can preferably be e.g. about 10-20 steps, more preferably e.g. about 12-18 steps, and most preferably e.g. about 14-16 steps in the combustion chamber 110.

The steps 138 can be made of any suitable material, such as steel, which is durable in high temperature, e.g. AISI 304. The length of steps corresponds to the length of the combustion chamber in axial direction, i.e. the steps extend the whole length of the combustion chamber in axial direction. The form of the steps can vary depending on embodiment, but preferably, the steps 138 have a shape of L-profile comprising a longer part 302 and a shorter part 304, as clearly can be seen in FIG. 3. The lengths of the part 302 and 304 may vary depending on embodiment and size of the chamber, but the longer part 302 can preferably be e.g. about 30 mm-60 mm, more preferably e.g. about 35 mm-50 mm, and most preferably e.g. about 40 mm-55 mm. Respectively, the shorter part 304 can preferably be e.g. about 10 mm-25 mm, more preferably e.g. about 12 mm-20 mm, and most preferably e.g. about 15 mm-17 mm.

In one embodiment, the steps and/or the inner surface of the combustion chamber is coated with some appropriate, high temperature resistant material. The used coating material is preferably ceramic material, such as, but not limited to, Titanium nitride (TiN), which is extremely hard material having a high melting point, 2930° C. A person skilled in art will appreciate that TiN is just an exemplary material and others suitable coating materials can also be used in this invention. The coating layer can be e.g. about 5 μm, but a person skilled in art will understand that the coating layer can be more or less as far it provides sufficient protection to the combustion chamber and alleviates movements and collisions of combustion fuel particles.

The combustion air flow and direction in the combustion chamber are controlled by apertures provided in suitable positions in the combustion chamber 110 and additionally, in the afterburning part 114.

In one embodiment, at least one aperture 140 is provided through at least one step 138 as to guiding the primary combustion air into the combustion chamber 110 in a direction substantially parallel to and/or along a circumference of the combustion chamber 110 for contributing combustion and moving combustion fuel on the steps 138. In a preferred embodiment, the primary air vortex in the combustion chamber is achieved with an aperture row, wherein the apertures 140 are evenly disposed in the row in every step 138, and further, in another embodiment, the aperture row is provided in the shorter part 304 of a step 138. Typically, a step comprises preferably e.g. about 1-4 apertures/10 mm, more preferably e.g. about 2-3 apertures/10 mm. The diameter of the apertures 140 can preferably be e.g. about 3 mm-5.5 mm, more preferably e.g. about 3.5 mm-5 mm, and most preferably e.g. about 4-4.5 mm.

The apertures 140 through the steps 138 are disposed and directed so that primary combustion air guided through the apertures 138 is directed to the circumference of the combustion chamber causing it to sweep the surface of the longer part 402 of the adjacent step 138, as is elucidated with gray arrows in FIG. 5. This arrangement of primary combustion air causes the primary air vortex inside the combustion chamber 110.

The vortex of the primary combustion air inside the combustion chamber is essential to ensure total combustion of fuel and to elevate completely combusted fuel into the secondary combustion air, which removes the completely combusted fuel, i.e. ash, and gases from the combustion chamber.

At least one aperture 204 is provided through the centre plate 125 for providing secondary combustion air into the combustion chamber 110 for removing completely combusted fuel and/or combustion gases from the combustion chamber 110. Normally, the centre plate 125 comprises preferably e.g. about 4-10 apertures, more preferably e.g. about 5-9 apertures, and most preferably e.g. about 6-8 apertures. The diameter of the apertures can preferably be e.g. 3 mm-5.5 mm, more preferably e.g. 3.5 mm-5 mm, and most preferably e.g. 4-4.5 mm.

The air flow of the secondary combustion air is substantially parallel to the rotation axis of the combustion chamber 110 in a direction to the end of the combustion chamber 110, where, in some embodiments, locates the afterburning part 114, and, finally, out from the combustion chamber 110. The secondary combustion air together with primary combustion air cause a negative pressure area near the secondary combustion air flow in the combustion chamber 110, which causes, in turn, sufficiently lightweight combustion particles and/or combustion gases to be sucked into the secondary combustion air and out from the combustion chamber 110.

As described above, the end of the combustion chamber 110 is open for providing a passage for completely combusted fuel and/or combustion gases to exit from the combustion chamber 110. In one embodiment, the end of the combustion chamber comprises a collar or a flange for diminishing the radius of the open end. The purpose of the diminished opening is to prevent incompletely combusted fuel to fall out from the combustion chamber 110. The same effect is achieved with an embodiment using the afterburning part, as described below.

In some embodiments, the combustion device 100 according to the present invention further comprises the afterburning part 114, which afterburning part 114 is connected to the end of the chamber 102 of the combusting device 100 and is in connection with the end of the combustion chamber 110. The afterburning part 114 is for ensuring complete combustion of combustion fuel and/or combustion gases, as well as for preventing incompletely combusted material to exit from the combustion chamber 110. In addition, the afterburning part 114 is provided to gather, concentrate and choke the burning gases in a controlled manner. The form of the afterburning part 114 can be e.g. cylindrical collar providing an output opening 115 for completely combusted fuel, i.e. ash, and/or combustion gases. Advantageously, the output opening 115 formed by the afterburning part 114 has a smaller radius than the open end of the combustion chamber 110. The radius of the output opening 115 of the afterburning part 114 can preferably be e.g. about 10%-40% smaller, more preferably e.g. about 15%-35% smaller, most preferably e.g. about 20%-30% smaller than the radius of the open end of the combustion chamber 110.

The smaller radius of the output opening 115 of the afterburning part 114 physically prevents incompletely combusted fuel to exit from the combustion chamber 110 due to the rotation movement of the combustion chamber 100 and/or primary and/or secondary combustion air. However, completely combusted fuel, i.e. ash, and combustion gases can exit from the combustion chamber 110 via output opening 115 of the afterburning part 114 along secondary combustion air provided to the combustion chamber 110 in a direction substantially parallel to the rotation axis of the combustion chamber 110 from the centre plate 125 to the output opening 115. Further, some ash collecting vessel may be disposed after the afterburning part 114 for collecting ash.

In one embodiment, the afterburning part 114 further comprises at least one aperture 136 provided through the afterburning part 114 for directing afterburning combustion air in a substantially radial direction of the afterburning part 114 into the end of the combustion chamber 110 for ensuring complete combustion of combustion fuel and/or combustion gases. In some other embodiments, the aperture/apertures are disposed so that the afterburning combustion air is directed in an opposite direction comparing to the secondary combustion air flow. Preferably, the aperture/apertures 136 are disposed through the collar of the afterburning part 114.

In FIG. 1 can be seen, that the afterburning part 114 comprises a number of apertures 136 arranged in two rows. A person skilled in the art will appreciate that there can be apertures for afterburning combustion air in one or more rows as far as the diameter of apertures and the direction they direct the afterburning combustion air flow are suitable with respect to other apertures in the combustion device, because, in the present invention, a common combustion air space and preferably only one blast apparatus are used.

Typically, the afterburning part 114 comprises preferably e.g. 20-200 apertures, more preferably e.g. 50-150 apertures, and most preferably e.g. 100-125 apertures. The diameter of the apertures can preferably be e.g. about 0.2 mm-1.0 mm, more preferably e.g. about 0.3 mm-0.7 mm, and most preferably e.g. about 0.4-0.6 mm.

The afterburning part 114 is preferably arranged to be replaceable. This feature can be advantageous, because the afterburning of the fuel and combustion gases provided by afterburning combustion air may further increase the temperature of combustion gases e.g. 100° C.-150° C. However, in some embodiments, the same blast apparatus 112 provides both cooling and the afterburning combustion air for the afterburning part.

Next, a method for combusting granular, solid fuel 600 using combustion device according to the present invention is discussed.

In one embodiment, at phase 602, granular, solid, ignited fuel is fed to the beginning of the combustion chamber. Normally, the feeding is performed by using the feeding device 116 and lighting means 118, as described above, but a person skilled in art will appreciate that the feeding and lighting can be performed in some other way or in some other device than described above.

At phase 604, the combustion chamber is provided into a rotating movement, and at phase 606, primary combustion air flow is provided into the combustion chamber in a direction substantially parallel to and/or along the circumference of said combustion chamber. Further, at phase 608 secondary combustion air is provided into the combustion chamber in a direction substantially parallel to the rotation axis of said combustion chamber.

When combining the primary air vortex in the combustion chamber with the rotation and/or pulsating of the combustion chamber, the combustion process according to the present invention is achieved. During the combustion process, the combustion particles in the combustion chamber are lifted by the steps and primary combustion air contributes the burning process, mixes combustion fuel particles and makes them collide with each other, which, in turn, breaks the fuel particles to smaller parts, and, further, causes dropping of heavier particles to a lower step. Thus, the combustion process may separate heavier particles from lighter particles and may prevent melted particles to stick to the inner surface of the combustion chamber. Furthermore, primary combustion air and the rotating movement together alleviate lighter particles to raise upper in the combustion chamber toward the negative pressure area provided by primary combustion air and secondary combustion air together, as described above, and further to be sucked into the secondary combustion air flow, when they are sufficiently lightweight, i.e. when the combustion fuel particles are completely burned into ash. In addition, the rotating movement lifts burning fuel to an upper step away from new fuel to be fed into the bottom of the combustion chamber by the gravity, and when a fuel particle, too heavy to be sucked into the negative pressure area, finally drops to the bottom of the combustion chamber by the rotation movement, it will drop onto the new fuel fed into the combustion chamber, which may, in turn, improve the complete combustion of fuel.

In a supplementary embodiment, at phase 610, afterburning combustion air is provided through aperture(s), which is provided through said afterburning part into the end of said combustion chamber. This afterburning combustion process ensures complete combustion of combustion fuel and/or combustion gases by providing air flow in appropriate direction, which air flow increases the temperature of ash and combustion gases at the location of the afterburning part.

After phase 608 or, in a supplementary embodiment, after phase 610, the method further continues from step 602 as long as required.

Generally, the feeding process can be adjusted based on information provided by e.g. thermostat or some other means. Preferably, the combustion process is anyway continuous, and small flame is maintained in the combustion device. This is advantageous, because starting process may cause a peak of undesired fine particles in air. The feeding process and the combustion process can typically be adjusted steplessly, i.e. regardless of the volume of the combustion chamber sufficiently small amount of combustion fuel can be fed to the combustion chamber in order to carry on the combustion process.

1-18. (canceled)

19. A combustion device for combusting granular solid fuel, said combustion device comprising:
a chamber having an outer wall and an inner wall, which inner wall divides an inner space of said chamber into a combustion air space and a combustion chamber,
at least one blast apparatus for providing combustion air, and
rotating means for rotating said combustion chamber,
wherein said inner surface of said combustion chamber comprises a number of steps for lifting combustion fuel in said combustion chamber, and
at least one aperture is provided through at least one step for directing a primary combustion air into said combustion chamber in a direction substantially parallel to and/or along a circumference of said combustion chamber for contributing combustion of combustion fuel and for moving said combustion fuel on said steps,
and said combustion chamber comprises at least one aperture for providing a secondary combustion air into said combustion chamber in a direction substantially parallel to a rotation axis of said combustion chamber for removing completely combusted fuel and optionally combustion gases from said combustion chamber,
wherein the rotating movement of the combustion chamber provided by said rotating means and said primary combustion air together elevate completely combusted fuel into said secondary combustion air in order to be removed from said combustion chamber.

20. A combustion device according to claim 19, wherein said combustion chamber is a shape of a cylinder having an open end for removing completely combusted fuel from said combustion chamber.

21. A combustion device according to claim 19, wherein said combustion device further comprises an afterburning part, comprising an output opening for removing completely combusted fuel from said combustion chamber, which afterburning part is in connection with said combustion chamber for preventing incompletely combusted material to exit from said combustion chamber.

22. A combustion device according to claim 21, wherein the radius of said output opening of said afterburning part is 10%-40% smaller than the radius of the open end of the combustion chamber.

23. A combustion device according to claim 21, wherein the radius of said output opening of said afterburning part is 15%-35% smaller than the radius of the open end of the combustion chamber.

24. A combustion device according to claim 21, wherein the radius of said output opening of said afterburning part is 20%-30% smaller than the radius of the open end of the combustion chamber.

25. A combustion device according to claim 21, wherein afterburning combustion air is provided into the afterburning part and at least one aperture is provided through said afterburning part for directing afterburning combustion air into the end of said combustion chamber for ensuring complete combustion of said combustion fuel and combustion gases.

26. A combustion device according to claim 19, wherein said combustion air space is continuous.

27. A combustion device according to claim 19, wherein one blast apparatus provides both primary combustion air and secondary combustion air.

28. A combustion device according to claim 19, wherein said steps are coupled together.

29. A combustion device according to claim 19, wherein said steps are L-profile-shaped.

30. A combustion device according to claim 29, wherein said aperture/apertures is/are provided to the short side of said L-shaped step.

31. A combustion device according to claim 19, wherein the rotating movement of said combustion chamber is pulsating.

32. A combustion device according to claim 31, wherein said pulsating rotating movement of said combustion chamber is adjustable according to the fuel type and/or size.

33. A combustion device according to claim 19, wherein said device further comprises a feeding device comprising a feeding tube, a protective valve, conveying means, a flame control system and/or extinguishing equipment for feeding combustion fuel to said combustion chamber and for controlling the feeding and/or ignition process.

34. A combustion device according to claim 19, wherein said device further comprises a lighting means, such as electric and/or wire-wound resistor, for igniting said combustion fuel by means of heating said combustion air.

35. A method for combusting granular, solid fuel using combustion device according to claim 19, comprising at least following phases:
feeding granular, solid, ignited fuel to the beginning of said combustion chamber;
providing said combustion chamber into a rotating movement for lifting fuel by means of said steps forming the inner surface of said combustion chamber;
providing primary combustion air into said combustion chamber in a direction substantially parallel to and/or along the circumference of said combustion chamber for combusting and moving said combustion fuel in said combustion chamber;
providing secondary combustion air into said combustion chamber in a direction substantially parallel to a rotation axis of said combustion chamber for removing completely combusted fuel and/or combustion gases from said combustion chamber.

36. A method according to claim 35 further comprises following phases:
providing combustion air through aperture(s) provided through said afterburning part in a substantially radial direction of the afterburning part into the end of said combustion chamber for ensuring complete combustion of combustion fuel and/or combustion gases.

37. A method for combusting granular, solid fuel using combustion device according to claim 20, comprising at least following phases:
feeding granular, solid, ignited fuel to the beginning of said combustion chamber;
providing said combustion chamber into a rotating movement for lifting fuel by means of said steps forming the inner surface of said combustion chamber;
providing primary combustion air into said combustion chamber in a direction substantially parallel to and/or along the circumference of said combustion chamber for combusting and moving said combustion fuel in said combustion chamber;
providing secondary combustion air into said combustion chamber in a direction substantially parallel to a rotation axis of said combustion chamber for removing completely combusted fuel and/or combustion gases from said combustion chamber.

38. A method for combusting granular, solid fuel using combustion device according to claim 21, comprising at least following phases:
feeding granular, solid, ignited fuel to the beginning of said combustion chamber;
providing said combustion chamber into a rotating movement for lifting fuel by means of said steps forming the inner surface of said combustion chamber;
providing primary combustion air into said combustion chamber in a direction substantially parallel to and/or along the circumference of said combustion chamber for combusting and moving said combustion fuel in said combustion chamber;
providing secondary combustion air into said combustion chamber in a direction substantially parallel to a rotation axis of said combustion chamber for removing completely combusted fuel and/or combustion gases from said combustion chamber.
